(19) United States
(12) Patent Application Publication
(10) Pub. No.: US 2013/0054418 A1
(43) Pub. Date: Feb. 28, 2013

(54) Methods for Telco's Application Store Management

(71) Applicant: Ju-Ting Yang, Taoyuan County (TW)

(72) Inventor: Ju-Ting Yang, Taoyuan County (TW)

(21) Appl. No.: 13/592,353

(22) Filed: Aug. 23, 2012

Related U.S. Application Data
(60) Provisional application No. 61/527,624, filed on Aug. 26, 2011.
(60) Provisional application No. 61/551,454, filed on Oct. 26, 2011.

(51) Int. Cl. G06Q 30/00; G06Q 10/00

(52) U.S. Cl. 705/26.61; 705/26.1

(57) ABSTRACT

A method of application store management in a Telco's Application Store (TAS) system developed by Open Mobile Alliance (OMA), the TAS system having a TAS client component and a storefront component, the method includes transmitting an application download status report message to the storefront component by the TAS client component for reporting a download status of an application to the storefront component; and receiving an application download status response message in response to the application download status report message by the TAS client component, wherein the application download status response message is transmitted by the storefront component.

### CROSS REFERENCE TO RELATED APPLICATIONS

This application claims the benefit of U.S. Provisional Application No. 61/527,624, filed on Aug. 26, 2011 and entitled “Message Details of Application Management Operation in Telco's Application Store”, and the benefit of U.S. Provisional Application No. 61/551,454, filed on Oct. 26, 2011 and entitled “Message Details in Telco's Application Store”, the contents of which are incorporated herein in their entirety.

### BACKGROUND OF THE INVENTION

1. Field of the Invention

The invention relates to methods used in a service system, and more particularly, to methods for application store management such as application download status report, application sale information notification, application sorting, application search and application deletion in a Telco's Application Store (TAS) system developed by Open Mobile Alliance (OMA).

2. Description of the Prior Art

Open Mobile Alliance (OMA) is founded to develop OMA specifications for mobile services to meet users' needs. Furthermore, the OMA specifications aim to provide the mobile services which are interoperable across geographic areas (e.g. countries), operators, service providers, networks, operation systems and mobile devices. In detail, the mobile services conforming to the OMA specifications can be used by the users without restriction to particular operators and service providers. The mobile services conforming to the OMA specifications are also bearer agnostic, i.e., the bearer that carries the mobile services can be a second generation (2G) mobile system such as Global System for Mobile Communications (GSM), Enhanced Data rates for GSM Evolution (EDGE) or General Packet Radio Service (GPRS), or a third generation (3G) and beyond mobile system such as Universal Mobile Telecommunications System (UMTS), Long Term Evolution (LTE) or LTE-Advanced (LTE-A). Further, the mobile services can be executed on an operation system such as Windows, Android or Linux operated on various mobile devices. Therefore, industries providing devices or the mobile services supporting the OMA specifications can benefit from a largely growing market enabled by interoperability of the mobile services. Besides, the users use the devices or the mobile services supporting the OMA specifications can also have a better experience due to the interoperability of the mobile services.

Besides, the OMA develops a Telco's Application Store (TAS) specification for specifying sale, access, and development of applications (e.g., softwares), to promote the TAS specification to users and developers. In detail, a TAS system includes entities such as a TAS client component, a storefront component and a developer support component. The TAS client component can interact with the storefront component, for example, browsing and downloading the applications provided by the storefront component, and maintaining an installation status of a downloaded application. After the TAS client component is installed in a device (e.g., a mobile device or a personal computer), the TAS client component can deliver capability information of the device to the storefront component by using existed transport protocols (e.g., HTTP User Agent Profile) when the TAS client component requests to browse the applications, such that the storefront component can provide the applications to the TAS client component according to the capability information of the device. Please note that, an application must pass an audit process at the developer support component, before the application is displayed by the storefront component to the TAS client component. The developer support component manages the applications uploaded by the developers, and audits the uploaded applications and their related information.

However, the TAS specification does not specify criteria of application download status report, application sale information notification, application sorting, application search or application deletion. Without such criteria, the storefront component can neither recognize messages from a TAS client component for requesting application download status report, application sorting or application search, nor recognize messages from a developer support component for application deletion, nor notify a developer support component about application sale information.

### SUMMARY OF THE INVENTION

It is therefore a primary objective of the invention to provide methods for application store management such as application download status report, application sale information notification, application sorting, application search and application deletion in a Telco's Application Store (TAS) system developed by Open Mobile Alliance (OMA) to solve the aforementioned problems.

In one aspect of the invention, a method of application store management in a TAS system is disclosed. The TAS system includes a client and a storefront component. The method includes transmitting an application download status report message to the storefront component by the client, for reporting a download status of an application to the storefront component; and receiving, an application download status response message in response to the application download status report message by the client, wherein the application download status response message is transmitted by the storefront component.

In one aspect of the invention, a method of application store management in a TAS system is disclosed. The TAS system includes a storefront component and a developer support component. The method includes transmitting an application sale information notification message to the developer support component by the storefront component, for reporting a sale information of an application to the developer support component; and receiving an application sale information response message in response to the application sale information notification message by the storefront component, wherein the application sale information response message is transmitted by the developer support component.

In one aspect of the invention, a method of application store management in a TAS system is disclosed. The TAS system includes a client and a storefront component. The method includes transmitting an application sorting request message to the storefront component by the client, for requesting the storefront component to perform application sorting; and receiving an application sorting response message in response to the application sorting request message by the client, wherein the application sorting response message is transmitted by the storefront component.

In one aspect of the invention, a method of application store management in a TAS system is disclosed. The TAS system includes a client and a storefront component. The method includes transmitting an application search request message to the storefront component by the client, for requesting the storefront component to perform application search; and receiving an application search response message in response to the application search request message by the client, wherein the application search response message is transmitted by the storefront component.

In one aspect of the invention, a method of application store management in a TAS system is disclosed. The TAS system includes a developer's portal component and a developer support component. The method includes transmitting an application deletion request message to the developer support component by the developer's portal component, for requesting the storefront component or the developer support component to delete an application; and receiving an application deletion response message in response to the application deletion request message by the developer's portal component, wherein the application deletion response message is transmitted by the developer support component.

In one aspect of the invention, a method of application store management in a TAS system is disclosed. The TAS system includes a developer support component and a storefront component. The method includes transmitting an application deletion request message to the storefront component by the developer support component, for requesting the storefront component to delete at least an application; and receiving an application deletion response message in response to the application deletion request message by the developer support component, wherein the application deletion response message is transmitted by the storefront component.

These and other objectives of the invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a Telco's Application Store system according to an example of the invention.

FIG. 2 is a schematic diagram of a communication device according to an example of the invention.

FIG. 3 is a flowchart of a process for application download status report in the TAS system according to an example of the invention.

FIG. 4 is a flowchart of a process for application sale information notification in the TAS system according to an example of the invention.

FIG. 5 is a flowchart of a process for application sorting in the TAS system according to an example of the invention.

FIG. 6 is a flowchart of a process for application search in the TAS system according to an example of the invention.

FIG. 7 is a flowchart of a process for application deletion in the TAS system according to an example of the invention.

FIG. 8 is a flowchart of a process for application deletion in the TAS system according to an example of the invention.

### DETAILED DESCRIPTION

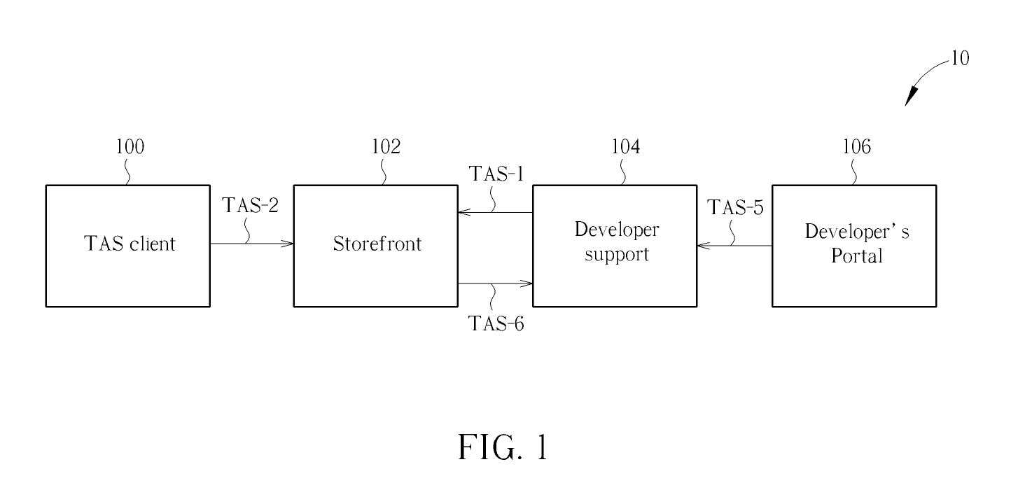

Please refer to FIG. 1, which is a schematic diagram of a Telco's Application Store (TAS) system 10 according to an example of the invention. The TAS system 10 supports a TAS specification developed by Open Mobile Alliance (OMA), and is briefly composed of a TAS client component 100, a storefront component 102, a developer support component 104 and a developer's portal component 106. The TAS client component 100 can be installed in devices such as mobile phones, laptops, tablet computers, electronic books, portable computer systems and computer systems, for browsing and downloading applications provided by the storefront component 102. Categories of the applications can include game, travel, entertainment, book, education, etc, wherein each of the applications can be free or not. In general, the storefront component 102 and the developer support component 104 are managed by a telecom operator or a service provider, and are installed in one or more servers, for providing the applications to the TAS client component 100 and managing the applications. The developer's portal component 106 acts as a portal for developers. Developers upload applications to the storefront component 102 by using a device in which the developer's portal component 106 is embedded.

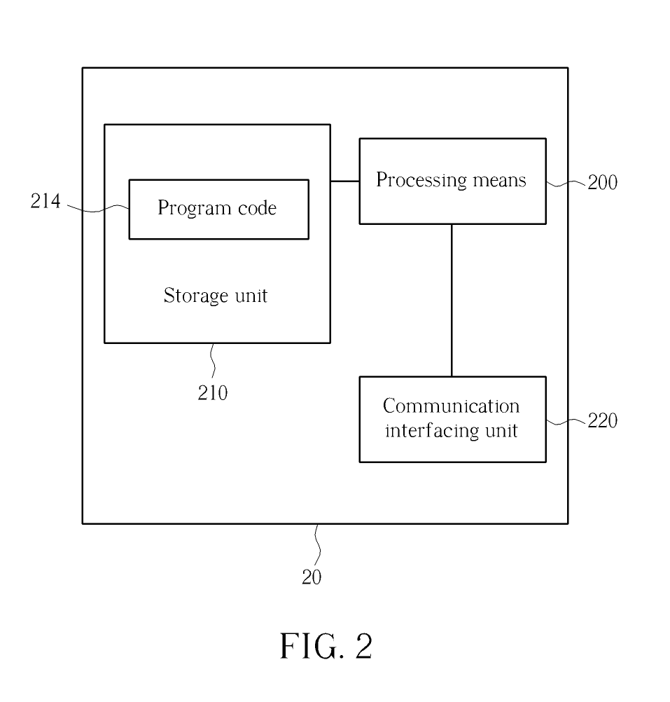

Please refer to FIG. 2, which is a schematic diagram of a communication device 20 according to an example of the invention. The communication device 20 can be a device in which the TAS client component 100 and/or the developer's portal component 106 is installed, or a server in which the storefront component 102 and/or the developer support component 104 is installed. The communication device 20 may include a processing means 200 such as a microprocessor or an Application Specific Integrated Circuit (ASIC), a storage unit 210 and a communication interfacing unit 220. The storage unit 210 may be any data storage device that can store a program code 214, accessed by the processing means 200. Examples of the storage unit 210 include but are not limited to a subscriber identity module (SIM), read-only memory (ROM), flash memory, random-access memory (RAM), CD-ROM/DVD-ROM, magnetic tape, hard disk, and optical data storage device. The communication interfacing unit 220 is preferably a transceiver, and can transmit/receive a message according to processing results of the processing means 200.

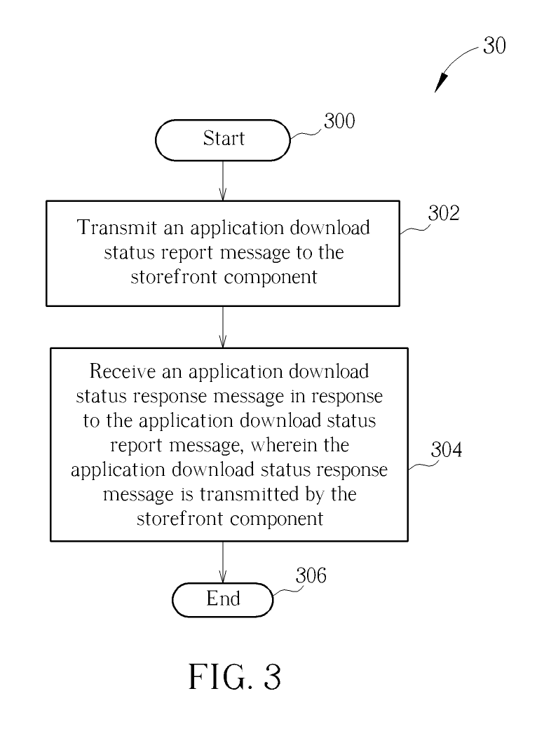

Please refer to FIG. 3, which is a flowchart of a process 30 for application download status report in the TAS system 10 according to an example of the invention. The TAS client component 100 is able to report download status of an application to the storefront component 102. The process 30 is utilized in the TAS client component 100 shown in FIG. 1, for reporting the download status of an application. The process 30 may be compiled into the program code 214 and includes the following steps:

Step 300: Start.

Step 302: Transmit an application download status report message to the storefront component.

Step 304: Receive an application download status response message in response to the application download status report message, wherein the application download status response message is transmitted by the storefront component.

Step 306: End.

According to the process 30, at a time when the TAS client component 100 intends to report download status of an application, the TAS client component 100 transmits an application download status report message to the storefront component 102, for reporting the download status of the application to the storefront component 102, wherein the application download status report message includes information related to the download status of the application. The information is provided to the storefront component 102 for acknowledging the download status of the application at the TAS client component 100. After processing the application download status report message, the storefront component 102 transmits the application download status response message to the TAS client component 100, for replying a result of processing the application download status response message, e.g., whether the application download status report message is successfully received. Consequently, by performing the process 30, the TAS client component 100 can report the download status of an application to the storefront component 102, such that the storefront component 102 may take further actions accordingly.

Please note that, one main spirit of the invention is that the TAS client component 100 transmits an application download status report message to the storefront component 102, for reporting the download status of an application, and receives an application download status response message transmitted by the storefront component 102 later, to know the result of processing the application download status report message at the storefront component 102. Details of the application download status report message and the application download status response message are not limited, as long as the aforementioned function can be realized. For example, TABLE 1 to TABLE 2 show the parameters of the application download status report message. In TABLE 1, the application download status report message includes a ClientID parameter, an ApplicationID parameter and an AppDownloadResult structure. The ClientID parameter is used for informing the storefront component 102 from whom the application download status report message is sent. The ApplicationID is used for explicitly (i.e., clearly) indicating the application to the storefront component 102. Here, the ClientID parameter denotes the identity (ID) of the TAS client component 100, the ApplicationID parameter denotes the ID of the application, and the AppDownloadResult structure represents the download result of the application. In TABLE 2, the AppDownloadResult structure includes an AppDownloadStatus parameter and a Description parameter. The AppDownloadStatus parameter denotes the download status of the application. The AppDownloadStatus parameter may be one of the following choices: successful, abandoned, incomplete and others. The choice “successful” represents that the application is completely downloaded by the TAS client component 100. The choice “abandoned” represents that download of the application is abandoned by the TAS client component 100. The choice “incomplete” represents that the application is downloading but not completely downloaded by the TAS client component. The choice “others” represents condition of downloading the application other than “successful”, “abandoned” and “incomplete”. The Description parameter denotes the detailed description corresponding to the selected choice of the AppDownloadStatus parameter.

TABLE 1

| Name | Cardinality | Data Type | Description |
|---|---|---|---|
| ClientID | 1 | String | The ID of the |
| | | | Storefront component |
| ApplicationID | 1 | String | The ID of the |
| | | | application |
| AppDownloadResult | 1 | Structure | Application download |
| | | | result |

TABLE 2

| Name | Cardinality | Data Type | Description |
|---|---|---|---|
| AppDownloadStatus | 1 | Enumeration | The download status |
| Description | 0 . . . 1 | String | The detailed |
| | | | information about |
| | | | the download status |

On the other hand, TABLE 3 shows the parameters of the application download status response message. In TABLE 3, the application download status response message includes a Result structure. The Result structure may include a status code, for indicating whether the application download status report message is successfully processed. If the application download status report message is successfully processed, the status code represents “success”. Otherwise, if the application download status report message is not successfully processed (e.g. the application download status report message is not successfully received or other reason), the status code represents other than “success”, and related error information may be included in the Result structure.

TABLE 3

| Name | Cardinality | Data Type | Description |
|---|---|---|---|
| Result | 1 | Structure | Status code and error |
| | | | information |

Preferably, the TAS client component 100 and the storefront component 102 communicate with each other via a TAS-2 interface. That is, the TAS client component 100 transmits the application download status report message to the storefront component 102 via the TAS-2 interface, and receives the application download status response message transmitted by the storefront component 102 via the TAS-2 interface. Please note that, a one-way arrow representing the TAS-2 interface shown in FIG. 1 means that only after the TAS-2 interface is initiated (e.g., transmitting the application download status report message) by the TAS client component 100, the storefront component can then respond (e.g., transmitting the application download status response message) to the TAS client component 100 via the TAS-2 interface.

Therefore, according to the process 30 and the aforementioned illustrations, a TAS client component can report the download status of an application to a storefront component which provides the application for downloading, such that the storefront component may take further actions accordingly.

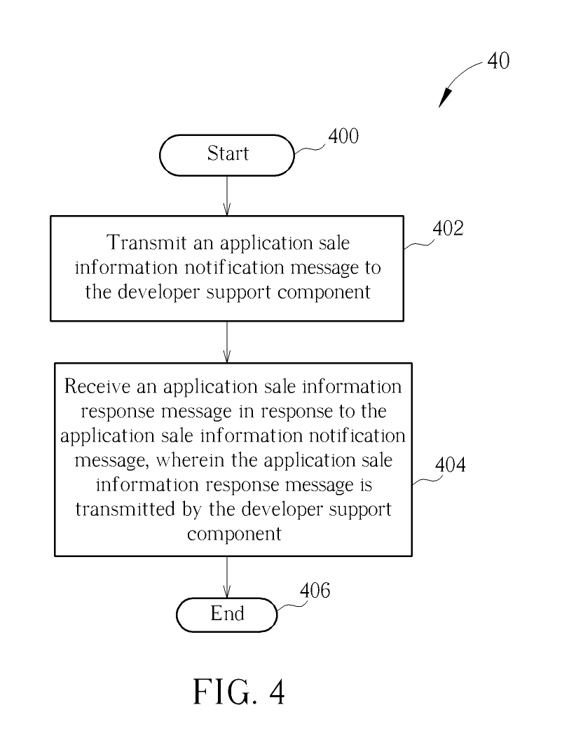

Please refer to FIG. 4, which is a flowchart of a process 40 for application sale information notification in the TAS system 10 according to an example of the invention. The storefront component 102 is able to notify sale information (e.g. download count, refund count and user rating) of an application to the developer support component 104. The process 40 is utilized in the storefront component 102 shown in FIG. 1, for notifying the developer support component 104 of sale information of the application. The process 40 may be compiled into the program code 214 and includes the following steps:

Step 400: Start.

Step 402: Transmit an application sale information notification message to the developer support component.

Step 404: Receive an application sale information response message in response to the application sale information notification message, wherein the application sale information response message is transmitted by the developer support component.

Step 406: End.

According to the process 40, at a time when the storefront component 102 intends to notify the developer support component 104 of sale information of an application, the storefront component 102 transmits an application sale information notification message to the developer support component 104. The application sale information notification message includes information related to the sale information of the application. The information is provided to the developer support component 104 for receiving the sale information of the application. After processing the application sale information notification message, the developer support component 104 transmits the application sale information response message to the storefront component 102, for replying a result of processing the application sale information notification message, e.g., whether the application sale information notification message is successfully received. Consequently, by performing the process 40, the storefront component 102 can notify the developer support component 104 of sale information of an application to the developer support component 104, such that the developer support component 104 may take further actions accordingly, e.g., provide sale information of the application for developer's request.

Please note that, one main spirit of the invention is that the storefront component 102 transmits an application sale information notification message to the developer support component 104, for notifying of sale information of an application, and receives an application sale information response message transmitted by the developer support component 104 later, to know the result of processing the application sale information notification message at the developer support component 104. Details of the application sale information notification message and the application sale information response message are not limited, as long as the aforementioned function can be realized. For example, TABLE 4 to TABLE 6 show the parameters of the application sale information notification message. In TABLE 4, the application sale information notification message includes a StoreID parameter and an AppSaleInfoList structure. The StoreID parameter is used for informing the developer support component from whom the application sale information notification message is sent. Here, the StoreID parameter denotes the ID of the storefront component 102, and the AppSaleInfoList structure represents list of application(s) in the application sale information notification message. In TABLE 5, the AppSaleInfoList structure includes an AppCount parameter and at least an AppSaleInfo structure. The AppCount parameter denotes the number of the application(s) in the application sale information notification message. Each AppSaleInfo structure is related to sale information of a specific application. In TABLE 6, the AppSaleInfo structure includes an ApplicationID parameter, an ApplicationName parameter, a StartDate parameter, an EndDate parameter, a DownloadInfo parameter, a ComplainInfo parameter a RefundInfo parameter, a RateInfo parameter and a Comment parameter. The ApplicationID parameter denotes the ID of the application. The ApplicationName parameter denotes the name of the application. The StartDate parameter and the EndDate parameter denote the start date and the end date of a certain period, respectively. The DownloadInfo parameter denotes the number of downloads within the certain period between the start date and the end date. The ComplainInfo parameter denotes the number of complains within the certain period. The RefundInfo parameter denotes the number of refunds within the certain period. The RateInfo parameter denotes the averaged user rating within the certain period. The Comment parameter denotes a comment on the application.

TABLE 4

| Name | Cardinality | Data Type | Description |
|---|---|---|---|
| StoreID | 1 | String | The ID of the Storefront |
| | | | component |
| AppSaleInfoList | 0 . . . 1 | Structure | List of application(s) |
| | | | in the sale information |

TABLE 5

| Name | Cardinality | Data Type | Description |
|---|---|---|---|
| AppCount | 1 | Integer | Number of applications |
| | | | in this list |
| AppSaleInfo | 0 . . . N | Structure | The application sale |
| | | | information |

TABLE 6

| | | Data | |
|---|---|---|---|
| Name | Cardinality | Type | Description |
| ApplicationID | 1 | String | The ID of the application |
| ApplicationName | 1 | String | The name of the |
| | | | application |
| StartDate | 1 | Date | Start date of the period |
| EndDate | 1 | Date | End date of the period |
| DownloadInfo | 1 | Integer | How many times of |
| | | | downloads within certain |
| | | | period |
| ComplainInfo | 1 | Integer | How many times of |
| | | | complains within certain |
| | | | period |
| RefundInfo | 1 | Integer | How many times of refund |
| | | | within certain period |
| RateInfo | 1 | Integer | The average rate given |
| | | | within certain period |
| Comment | 0 . . . 1 | String | The Comment content of |
| | | | the application received |

On the other hand, TABLE 7 shows the parameters of the application sale information response message. In TABLE 7, the application sale information response message includes a Result structure. The Result structure may include a status code, for indicating whether the application sale information notification message is successfully processed. If the application sale information notification message is successfully processed by the developer support component 104, the status code represents “success”. Otherwise, if the application sale information notification message is not successfully processed (e.g. the application sale information notification message is not successfully received or other reason), the status code represents other than “success”, and related error information may be included in the Result structure.

TABLE 7

| Name | Cardinality | Data Type | Description |
|---|---|---|---|
| Result | 1 | Structure | Status code and error |
| | | | information |

Preferably, the storefront component 102 and the developer support component 104 communicate with each other via a TAS-6 interface. That is, the storefront component 102 transmits the application sale information notification message to the developer support component 104 via the TAS-6 interface, and receives the application sale information response message transmitted by the developer support component 104 via the TAS-6 interface. Please note that, a one-way arrow representing the TAS-6 interface shown in FIG. 1 means that only after the TAS-6 interface is initiated (e.g., transmitting the application sale information notification message) by the storefront component 102, the developer support component 104 can then respond (e.g., transmitting the application sale information response message) to the storefront component 102 via the TAS-6 interface.

Therefore, according to the process 40 and the aforementioned illustrations, a storefront component can notify the sale information of an application to a developer support component, such that the developer support component may take further actions accordingly, e.g., provide sale information of the application for developer's request.

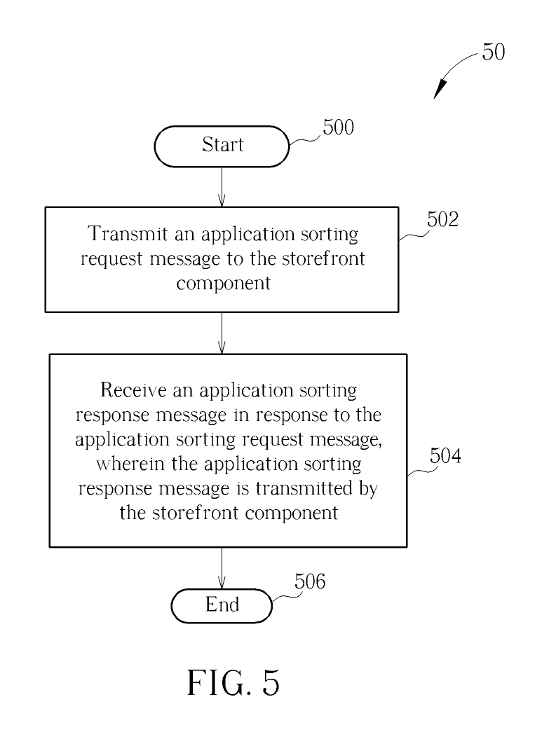

Please refer to FIG. 5, which is a flowchart of a process 50 for application sorting in the TAS system 10 according to an example of the invention. The TAS client component 100 is able to initiate application sorting request to the storefront component 102, and the storefront component 102 is able to perform sorting of its applications accordingly. The process 50 is utilized in the TAS client component 100 shown in FIG. 1, for initiating the application sorting request. The process 50 may be compiled into the program code 214 and includes the following steps:

Step 500: Start.

Step 502: Transmit an application sorting request message to the storefront component.

Step 504: Receive an application sorting response message in response to the application sorting request message, wherein the application sorting response message is transmitted by the storefront component.

Step 506: End.

According to the process 50, at a time when a user, who uses a device where the TAS client component 100 is installed and the process 50 is performed such as the communication device 20, intends to perform application sorting, the TAS client component 100 transmits an application sorting request message to the storefront component 102, for requesting the storefront component 102 to sort applications of the storefront component 102, wherein the application sorting request message includes information related to sorting criteria (e.g. by user rating, by download number within a specific time period or by price) for sorting the applications. The information is provided to the storefront component 102 for requesting the storefront component 102 to apply the sorting criteria desired by the user. After processing the application sorting request message, the storefront component 102 transmits the application sorting response message to the TAS client component 100, for replying a result of processing the application sorting request message, e.g., whether the application sorting request message is successfully received or whether sorting of the applications is successful. Consequently, by performing the process 50, the TAS client component 100 can request the storefront component 102 for sorting the applications, such that the storefront component 102 may start sorting the applications according to the sorting criteria in the application sorting request message.

Please note that, one main spirit of the invention is that the TAS client component 100 transmits an application sorting request message to the storefront component 102, for requesting the storefront component 102 to sort applications, and receives an application sorting response message transmitted by the storefront component 102 later, to acquire the sorting result of the applications. Details of the application sorting request message and the application sorting response message are not limited, as long as the aforementioned function can be realized. For example, TABLE 8 shows the parameters of the application sorting request message. In TABLE 8, the application sorting request message includes a ClientID parameter, a Criteria parameter and an Order parameter. The ClientID parameter is used for informing the storefront component 102 from whom the application sorting request message is sent. Here, the ClientID parameter denotes the ID of the TAS client component 100. The Criteria parameter in the application sorting request message is used for indicating the storefront component 102 which sorting criteria shall be applied for the storefront component 102 to perform sorting. The Criteria parameter may include at least one of the following choices: name, price, download number, effective date, user rating and others. The choice “name” represents sorting by application name. The choice “price” represents sorting by application price. The choice “download number” represents sorting by application download number within a specific time period set by the service provider. The choice “effective date” represents sorting by application effective date. The choice “user rating” represents sorting by application user rating. The choice “others” represents sorting by criteria other than “name”, “price”, “download number”, “effective date” and “user rating”. The user may choose “others” as the Criteria parameter as long as it can be readable and acceptable by the storefront component 102. The Order parameter is used for indicating the storefront component 102 which sorting order shall be applied. The Order parameter may include at least one of the following choices: ascent and descent. The choice “ascent” represents sorting in ascending order. The choice “descent” represents sorting in ascending order. Either sorting by descending order or sorting by ascending order is set as the default sorting order if the Order parameter is missing in the application sorting request message.

TABLE 8

| Name | Cardinality | Data Type | Description |
|---|---|---|---|
| ClientID | 1 | String | The ID of the TAS client |
| | | | component |
| Criteria | 1 | Integer | The criteria to apply on |
| | | | application sorting in |
| | | | the storefront |
| | | | component |
| Order | 0 . . . 1 | Boolean | Sorting by ascending |
| | | | order or by descending |
| | | | order |

On the other hand, TABLE 9 to TABLE 11 show the parameters of the application sorting response message. In TABLE 9, the application sorting response message includes a Result structure and an AppInfoList structure. The Result structure may include a status code, for indicating whether the application sorting is successfully performed. If the application sorting is successfully performed, the status code represents “success”. Otherwise, the application sorting fails (e.g. if the application sorting request message is not successfully received, or if the application sorting request message is not successfully processed by the storefront component 102, or incorrect sorting criteria is included in the Criteria parameter or other reason), the status code represents “fail”, and related error information may be included in the Result structure. The AppInfoList structure denotes application list based on the applied sorting criteria. The AppInfoList structure is used for listing the sorting result of the applications based on the applied sorting criteria. In TABLE 10, the AppInfoList structure includes an AppCount parameter and at least an AppInfo structure. The AppCount parameter denotes the number of applications in the AppInfoList structure. Each AppInfo structure is related to information of a specific application. In TABLE 11, the AppInfo structure includes an ApplicationID parameter, an ApplicationName parameter, a DeveloperID parameter, a Type parameter, a Description parameter, a Status parameter, a Version parameter, a SubmitTime parameter, an EffectiveDate parameter, an ExpireDate parameter, a Price parameter, a Logo parameter, a Language structure, a Size parameter, a Whatsnew parameter and a Screenshot structure. The ApplicationID parameter denotes the ID of the application. The ApplicationName parameter denotes the name of the application. The DeveloperID parameter denotes the ID of a developer who develops the application. The Type parameter denotes the type of the application. The Type parameter may include at least one choice, such as “games”, “contents”, “tools”, “entertainment”, “books”, etc. The Description parameter denotes some text description to illustrate the application. The Status parameter denotes the audit status of the application. The Status parameter may include one of the following choices: submitted, audited, tested, online, offline and end. The choice “submitted” represents the application is successfully uploaded to the developer supported component 104 but not successfully audited. The choice “audited” represents the application is successfully audited but not successfully tested. The choice “tested” represents the application is successfully tested. The choice “online” represents the application is published on the storefront component 102. The choice “offline” represents the application is de-registered or not successfully uploaded. The choice “end” represents the application is deleted or revoked. The Version parameter denotes the current version of the application. The SubmitTime parameter denotes the time at which the application is submitted to the developer support component 104. The EffectiveDate parameter denotes the effective date on which the application becomes available to users. The ExpireDate parameter denotes the expiration date on which the application expires. The Price structure represents the price of the application to users. The Price structure includes a Value parameter and a Price-Unit-Code parameter. The Value parameter denotes the amount of the price of the application. The Price-Unit-Code parameter denotes the of a country, which may include a choice such as USD (US Dollar), EUR (Euro Dollar), RMB (Chinese Yuan), etc. The Logo parameter denotes the logo picture of the application. The Language parameter represents the language of the application. The Size parameter represents the size of the install files for installing the application in bytes. The Whatsnew parameter denotes the description of new features in the latest version of the application. The Screenshot structure represents the screenshots of the application. The screenshot structure includes an ImageCount parameter and at least a ScreenshotImage parameter. The ImageCount parameter denotes the number of screenshot images of the application. Each ScreenshotImage parameter denotes one screenshot image file of the application.

TABLE 9

| Name | Cardinality | Data Type | Description |
|---|---|---|---|
| Result | 1 | Structure | Status code and error |
| | | | information |
| AppInfoList | 0 . . . 1 | Structure | List of application |
| | | | ID(s) based on the |
| | | | applied criteria |

TABLE 10

| Name | Cardinality | Data Type | Description |
|---|---|---|---|
| Count | 1 | Integer | Number of applications |
| | | | in the list |
| AppInfo | 0 . . . N | Structure | The information of an |
| | | | application |

TABLE 11

| Name | Cardinality | Data Type | Description |
|---|---|---|---|
| ApplicationID | 1 | Integer | The ID of the |
| | | | application |
| ApplicationName | 1 | String | The name of the |
| | | | application |
| DeveloperID | 1 | String | The ID of the developer |
| Type | 1 | Enumerate | The type of the |
| | | | application |
| Description | 1 | String | Some text description to |
| | | | illustrate the |
| | | | application |
| Status | 1 | Enumerate | Status can be |
| | | | “submitted”, “audited”, |
| | | | “tested”, “online”, |
| | | | “offline”, “end”, etc. |
| Version | 1 | String | A version number |
| | | | typically in the format |
| | | | of “X.Y”, in which X and |
| | | | Y are integers |
| SubmitTime | 1 | Time | The time at which this |
| | | | application was |
| | | | submitted to the |
| | | | developer support |
| | | | component |
| EffectiveDate | 1 | Date | The date on which the |
| | | | application begins to be |
| | | | available to users |
| ExpireDate | 1 | Date | The date on which the |
| | | | application will expire |
| Price | 1 | Structure | The price of the |
| | | | application to users |
| Logo | 0 . . . 1 | Binary | The logo picture of the |
| | | | application |
| Language | 1 | Enumerate | The language of the |
| | | | application |
| Size | 1 | Integer | The size of application |
| | | | install files in bytes |
| Whatsnew | 1 | String | The description of |
| | | | what's new in latest |
| | | | version of the |
| | | | application |
| Screenshot | 1 | Structure | The screenshots of the |
| | | | application |

Preferably, the TAS client component 100 and the storefront component 102 communicate with each other via a TAS-2 interface. That is, the TAS client component 100 transmits the application sorting request message to the storefront component 102 via the TAS-2 interface, and receives the application sorting response message transmitted by the storefront component 102 via the TAS-2 interface. Please note that, a one-way arrow representing the TAS-2 interface shown in FIG. 1 means that only after the TAS-2 interface is initiated (e.g., transmitting the application sorting request message) by the TAS client component 100, the storefront component 102 can then respond (e.g., transmitting the application sorting response message) to the TAS client component 100 via the TAS-2 interface.

Therefore, according to the process 50 and the aforementioned illustrations, a TAS client component can request a storefront component to perform application sorting for acquiring a sorted application list in a sorting order by a sorting criteria according to a user's demand.

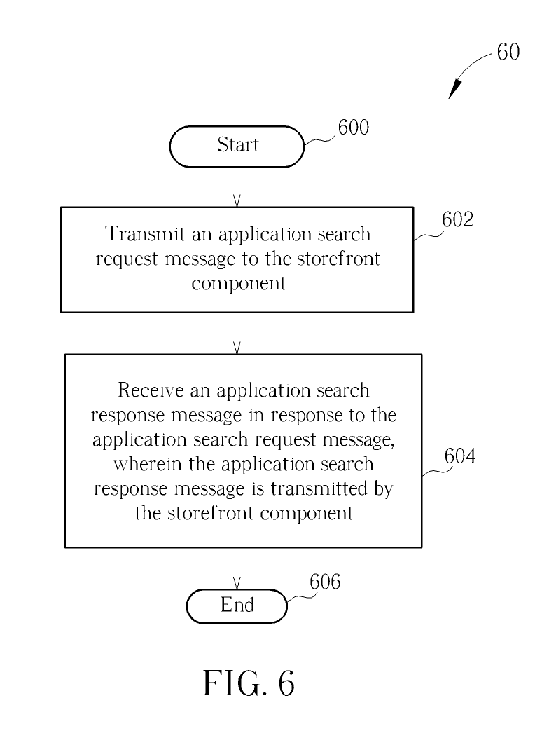

Please refer to FIG. 6, which is a flowchart of a process 60 for application search in the TAS system 10 according to an example of the invention. The TAS client component 100 is able to initiate application search request to the storefront component 102, and the storefront component 102 is able to perform search for applications accordingly. The process 60 is utilized in the TAS client component 100 shown in FIG. 1, for initiating the application search request. The process 60 may be compiled into the program code 214 and includes the following steps:

Step 600: Start.

Step 602: Transmit an application search request message to the storefront component.

Step 604: Receive an application search response message in response to the application search request message, wherein the application search response message is transmitted by the storefront component.

Step 606: End.

According to the process 60, at a time when a user, who uses a device where the TAS client component 100 is installed and the process 60 is performed such as the communication device 20, intends to perform application search, the TAS client component 100 transmits an application search request message to the storefront component 102, for requesting the storefront component 102 to search for applications, wherein the application search request message includes information related to search attributes (e.g. application name, application category, etc.) for application search. The information is provided to the storefront component 102 for requesting the storefront component 102 to apply the search attributes desired by the user for application search. After processing the application search request message, the storefront component 102 transmits the application search response message to the TAS client component 100, for replying a result of processing the application search request message, e.g., whether the application search request message is successfully received or whether the application search is successful. Consequently, by performing the process 60, the TAS client component 100 can request the storefront component 102 to perform application search, such that the storefront component 102 may start search process according to the searching attributes in the application search request message.

Please note that, one main spirit of the invention is that the TAS client component 100 transmits an application search request message to the storefront component 102, for requesting the storefront component 102 to perform application search, and receives an application search response message transmitted by the storefront component 102 later, to acquire the search result from the applications of the storefront component 102. Details of the application search request message and the application search response message are not limited, as long as the aforementioned function can be realized. For example, TABLE 12 to TABLE 13 show the parameters of the application search request message. In TABLE 12, the application search request message includes a ClientID parameter, a QuickSearch parameter and an AdvencedSearch structure. The ClientID parameter is used for informing the storefront component 102 from whom the application search request message is sent. Here, the ClientID parameter denotes the ID of the TAS client component 100. Both the QuickSearch parameter and the AdvancedSearch structure are used for indicating the storefront component 102 which search attribute(s) shall be applied for the storefront component 102 to perform application search. The QuickSearch parameter includes information, which is a single string for application search. In TABLE 13, the AdvancedSearch structure may include at least one of a MinPrice parameter, a MaxPrice parameter, a Developer parameter, a TerminalBrand parameter, a TerminalType parameter and an AppType parameter. The MinPrice parameter denotes search by minimum price. The MaxPrice parameter denotes search by maximum price. The Developer parameter denotes search by developer's name. The TerminalBrand parameter denotes search by device brand. The TerminalType parameter denotes search by device type. The AppType parameter denotes search by application type. The user may use at least one parameter of the AdvancedSearch structure for application search.

TABLE 12

| Name | Cardinality | Data Type | Description |
|---|---|---|---|
| ClientID | 1 | String | The ID of the TAS client |
| | | | component |
| QuickSearch | 0 . . . 1 | String | Related search |
| | | | attributes applied |
| AdvancedSearch | 0 . . . 1 | Structure | Related search |
| | | | attributes applied |

TABLE 13

| Name | Cardinality | Data Type | Description |
|---|---|---|---|
| MinPrice | 0 . . . 1 | Price | The minimum price |
| MaxPrice | 0 . . . 1 | Price | The maximum price |
| Developer | 0 . . . 1 | String | The URI of the developer |
| TerminalBrand | 0 . . . 1 | String | The brand name of the |
| | | | terminal |
| TerminalType | 0 . . . 1 | String | The type of the terminal |
| AppType | 0 . . . 1 | Enumeration | The type of the |
| | | | application |

On the other hand, TABLE 14 shows the structures of the application search response message. In TABLE 14, the application search response message includes a Result structure and an AppInfoList structure. The Result structure may include a status code, for indicating whether the application search is successfully performed. If the application search is successfully performed, the status code represents “success”. Otherwise, if the application search fails (e.g. the application search request message is not successfully received, or the application search request message is not successfully processed by the storefront component 102, or incorrect search attributes are included in the Criteria parameter or other reason), the status code represents “fail”, and related error information may be included in the Result structure. The AppInfoList structure is the same as that of the application sorting response message. Therefore, the contents of the AppInfoList structure are referred to Table 10 and Table 11, and detailed descriptions of the contents are not narrated herein.

TABLE 14

| Name | Cardinality | Data Type | Description |
|---|---|---|---|
| Result | 1 | Structure | Status code and error |
| | | | information |
| AppInfoList | 0 . . . 1 | Structure | List of application |
| | | | descriptor(s) based on |
| | | | the applied criteria |

Preferably, the TAS client component 100 and the storefront component 102 communicate with each other via a TAS-2 interface. That is, the TAS client component 100 transmits the application search request message to the storefront component 102 via the TAS-2 interface, and receives the application search response message transmitted by the storefront component 102 via the TAS-2 interface. Please note that, a one-way arrow representing the TAS-2 interface shown in FIG. 1 means that only after the TAS-2 interface is initiated (e.g., transmitting the application search request message) by the TAS client component 100, the storefront component 102 can then respond (e.g., transmitting the application search response message) to the TAS client component 100 via the TAS-2 interface.

Therefore, according to the process 60 and the aforementioned illustrations, a TAS client component can request a storefront component to perform application search process for acquiring an application search list in accordance with search attributes according to a user's demand.

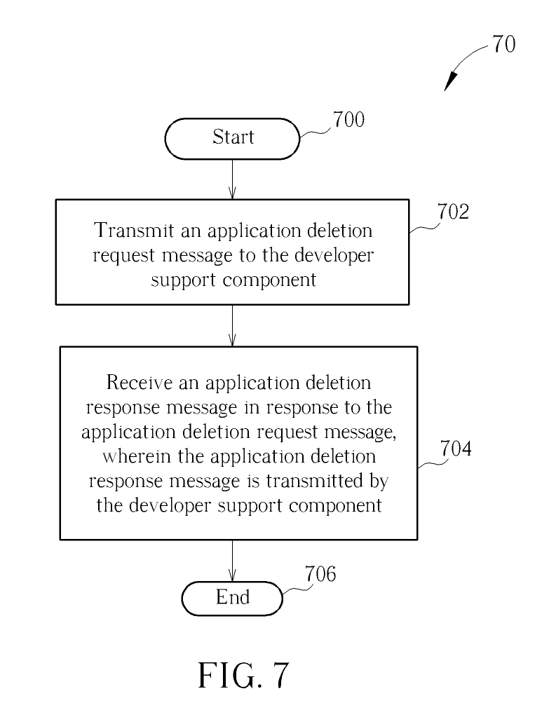

Please refer to FIG. 7, which is a flowchart of a process 70 for application deletion in the TAS system 10 according to an example of the invention. The developer's portal component 106 is able to initiate application deletion request to the developer support component 104 for deleting an application, the developer support component is able to forward the request to the storefront component 102, and the storefront component 102 is able to perform deletion of the application. The process 70 is utilized in the developer's portal component 106 shown in FIG. 1, for requesting the storefront component 102 or the developer support component 104 to delete an application. The process 70 may be compiled into the program code 214 and includes the following steps:

Step 700: Start.

Step 702: Transmit an application deletion request message to the developer support component.

Step 704: Receive an application deletion response message in response to the application deletion request message, wherein the application deletion response message is transmitted by the developer support component.

Step 706: End.

According to the process 70, at a time when a developer, who uses a device where the developer's portal component 106 is embedded and the process 70 is performed such as the communication device 20, intends to request the storefront component 102 to delete an application, the developer's portal component 106 transmits an application deletion request message to the developer support component 104, the application deletion request message including information related to an application to be deleted, such that the developer support component 104 forwards the information to the storefront component 102 for deleting the application. Once the deletion result of the application is received, the developer support component 104 transmits the application deletion response message to the developer's portal component 106, for replying the deletion result of the application. Consequently, by performing the process 70, the developer's portal component 106 can request the storefront component 102 to delete an application, such that the storefront component 102 may start application deletion process according to the information in the application deletion request message.

Please note that, one main spirit of the invention is that the developer's portal component 106 transmits an application deletion request message to the developer support component 104, for requesting the storefront component 102 or the developer support component 104, to delete an application, and receives an application deletion response message transmitted by the developer support component 104 later, to acquire the deletion result of the application. Details of the application deletion request message and the application deletion response message are not limited, as long as the aforementioned function can be realized. For example, TABLE 15 shows the parameters of the application deletion request message. In TABLE 15, the application deletion request message includes a DeveloperID parameter, an ApplicationID parameter and a Reason parameter. The DeveloperID parameter is used for informing the storefront component 102 from whom the application deletion request message is sent. The ApplicationID parameter is used for indicating the developer support component 104, which application shall be deleted by the storefront component 102. Here, the DeveloperID parameter denotes the ID of the developer's portal component 106, and the ApplicationID parameter denotes the ID of the application which is to be deleted. The Reason parameter denotes the reason why the application is to be deleted.

TABLE 15

| Name | Cardinality | Data Type | Description |
|---|---|---|---|
| DeveloperID | 1 | String | The ID of the TAS |
| | | | developer |
| ApplicationID | 1 | String | The ID of the |
| | | | application to be |
| | | | deleted |
| Reason | 0 . . . 1 | String | The reason to delete the |
| | | | application |

On the other hand, TABLE 16 shows the parameters of the application deletion response message. In TABLE 16, the application deletion response message includes a Result structure. The Result structure may include a status code, for indicating whether the application is successfully deleted. If the application is successfully deleted, the status code represents “success”. Otherwise, if the application is not successfully deleted (e.g. the application deletion request message is not successfully received or other reason), the status code represents other than “success”, and related error information may be included in the Result structure.

TABLE 16

| Name | Cardinality | Data Type | Description |
|---|---|---|---|
| Result | 1 | Structure | Status code and error |
| | | | information |

Preferably, the developer's portal component 106 and the developer support component 104 communicate with each other via a TAS-5 interface. That is, the developer's portal component 106 transmits the application deletion request message to the developer support component 104 via the TAS-5 interface, and receives the application deletion response message transmitted by the developer support component 104 via the TAS-5 interface. Please note that, a one-way arrow representing the TAS-5 interface shown in FIG. 1 means that only after the TAS-5 interface is initiated (e.g., transmitting the application deletion request message) by the developer's portal component 106, the developer support component 104 can then respond (e.g., transmitting the application deletion response message) to the developer's portal component 106 via the TAS-5 interface.

Therefore, according to the process 70 and the aforementioned illustrations, a developer's portal component can request a storefront component to perform application deletion process for deleting an application according to a developer's demand.

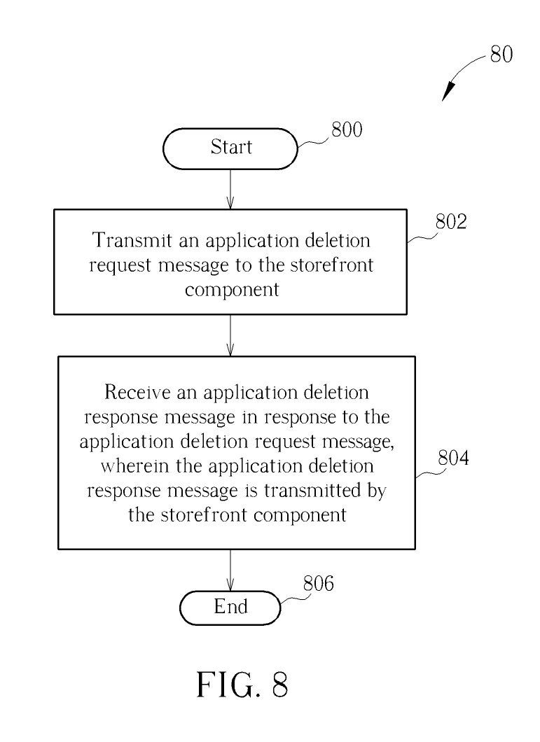

Please refer to FIG. 8, which is a flowchart of a process 80 for application deletion in the TAS system 10 according to an example of the invention. The developer support component 104 is able to forward application deletion request from the developer's portal component 106 to the storefront component 102 for deleting at least an application and forward deletion result from the storefront component 102 to the developer's portal component 106, and the storefront component 102 is able to perform deletion of the application(s). The process 80 is utilized in the developer support component 104 shown in FIG. 1, for requesting the storefront component 102 to delete at least an application. The process 80 may be compiled into the program code 214 and includes the following steps:

Step 800: Start.

Step 802: Transmit an application deletion request message to the storefront component.

Step 804: Receive an application deletion response message in response to the application deletion request message, wherein the application deletion response message is transmitted by the storefront component.

Step 806: End.

According to the process 80, at a time when the developer support component 104 receives a message related to application(s) to be deleted from the developer's portal component 106, the developer support component 104 transmits an application deletion request message including the information to the storefront component 102 for deleting the application(s). When receiving the application deletion request message, the storefront component 102 performs application deletion process to delete the application(s) and then transmits the application deletion response message to the developer support component 102, for replying a result of processing the application deletion request message, e.g., whether the application deletion request message is successfully received or whether the application(s) is/are successfully deleted. Consequently, by performing the process 80, the developer support component 104 can request the storefront component 102 to delete application(s) according to information related to the application(s) to be deleted from the developer's portal component 106, such that the storefront component 102 may start application deletion process accordingly.

Please note that, one main spirit of the invention is that the developer support component 104 transmits an application deletion request message to the storefront component 102, for requesting the storefront component 102 to delete application(s), and receives an application deletion response message transmitted by the storefront component 102 later, to forward the deletion result of the application deletion response message to the developer's portal component 106. Details of the application deletion request message and the application deletion response message are not limited, as long as the aforementioned function can be realized. For example, TABLE 17 shows the parameters of the application deletion request message. In TABLE 17, the application deletion request message includes a DeveloperID parameter, an AppIDList structure and a Reason parameter. The DeveloperID parameter is used for informing the storefront component 102 from whom the application deletion request message is sent. The AppIDList structure is used for indicating the storefront component 102 which application(s) shall be deleted by the storefront component 102. Here, the DeveloperID parameter denotes the ID of the developer's portal component 106, and the AppIDList structure denotes the ID(s) of the application(s) which is/are to be deleted. The Reason parameter denotes the reason why the application(s) is/are to be deleted.

TABLE 17

| Name | Cardinality | Data Type | Description |
|---|---|---|---|
| DeveloperID | 1 | String | The ID of the TAS |
| | | | developer |
| AppIDList | 1 | Structure | List of ID(s) of the |
| | | | application(s) to be |
| | | | deleted |
| Reason | 0 . . . 1 | String | The reason to delete the |
| | | | application(s) |

On the other hand, TABLE 18 shows the parameters of the application deletion response message. In TABLE 18, the application deletion response message includes a Result structure. The Result structure may include a status code, for indicating whether the application(s) is/are successfully deleted. If the application(s) is/are successfully deleted, the status code represents “success”. Otherwise, if the application(s) is/are not successfully deleted (e.g. the application deletion request message is not successfully received or other reason), the status code represents other than “success”, and related error information may be included in the Result structure.

TABLE 18

| Name | Cardinality | Data Type | Description |
|---|---|---|---|
| Result | 1 | Structure | Status code and error |
| | | | information |

Preferably, the developer support component 104 and the storefront component 102 communicate with each other via a TAS-1 interface. That is, the developer support component 104 transmits the application deletion request message to the storefront component 102 via the TAS-1 interface, and receives the application deletion response message transmitted by the storefront component 102 via the TAS-1 interface. Please note that, a one-way arrow representing the TAS-1 interface shown in FIG. 1 means that only after the TAS-1 interface is initiated (e.g., transmitting the application deletion request message) by the developer support component 104, the storefront component 102 can then respond (e.g., transmitting the application deletion response message) to the developer support component 104 via the TAS-1 interface.

Therefore, according to the process 80 and the aforementioned illustrations, a developer support component can request a storefront component to perform application deletion process for deleting application(s) according to message(s) related to application deletion from a developer's portal component, such that the storefront component may perform application deletion process to delete the application(s).

Note that, one main difference between the application deletion request message sent from the developer's portal component 106 and that sent from the developer support component 104 is, the application deletion request message sent from the developer's portal component 106 is used to request for deleting only one application, while the application deletion request message sent from the developer support component 104 is used to request for deleting at least one application. Specifically, the developer support component 104 may extract multiple application deletion request messages sent from the developer's portal component 106 and group several application IDs based on the same reason for deletion.

To sum up, the invention provides methods for application store management such as application download status report, application sale information notification, application sorting, application search and application deletion in the TAS system, such that the TAS client component can report download status of an application to the storefront component, the storefront component can notify sale information of an application to the developer support component, the TAS client component can request the storefront for application sorting or application search, and the developer's portal component can request the storefront for application deletion.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of application store management in a Telco's Application Store (TAS) system developed by Open Mobile Alliance (OMA), the TAS system having a TAS client component and a storefront component, the method comprising:
transmitting, by the TAS client component, an application download status report message to the storefront component, for reporting a download status of an application to the storefront component; and
receiving, by the TAS client component, an application download status response message in response to the application download status report message, wherein the application download status response message is transmitted by the storefront component.

2. The method of claim 1, wherein the application download status report message comprises at least one of an identity (ID) of the TAS client component, an ID of the application and an application download result.

3. The method of claim 2, wherein the application download result comprises at least one of an application download status and a description;
wherein the application download status comprises one of the following: successful, abandoned, incomplete and others.

4. The method of claim 1, wherein the application download status response message comprises a status code, for indicating whether the application download status report message is successfully processed.

5. A method of application store management in a Telco's Application Store (TAS) system developed by Open Mobile Alliance (OMA), the TAS system having a storefront component and a developer support component, the method comprising:
transmitting, by the storefront component, an application sale information notification message to the developer support component, for reporting a sale information of an application to the developer support component; and
receiving, by the storefront component, an application sale information response message in response to the application sale information notification message, wherein the application sale information response message is transmitted by the developer support component.

6. The method of claim 5, wherein the application sale information notification message comprises at least one of an identity (ID) of the storefront component and an application sale information list.

7. The method of claim 6, wherein the application sale information list comprises at least one of an application count and at least a sale information of at least an application;
wherein each of the at least a sale information comprises at least one of an identity, an application name, a download information, a complain information, a refund information, a user rating information and a comment of one of the at least an application.

8. The method of claim 5, wherein the application sale information response message comprises a status code, for indicating whether the application sale information notification message is successfully processed.

9. A method of application store management in a Telco's Application Store (TAS) system developed by Open Mobile Alliance (OMA), the TAS system having a TAS client component and a storefront component, the method comprising:
transmitting, by the TAS client component, an application sorting request message to the storefront component, for requesting the storefront component to perform application sorting; and
receiving, by the TAS client component, an application sorting response message in response to the application sorting request message, wherein the application sorting response message is transmitted by the storefront component.

10. The method of claim 9, wherein the application sorting request message comprises at least one of an identity (ID) of the TAS client component, a sorting criteria and a sorting order.

11. The method of claim 10, wherein the sorting criteria comprises at least one of the following: name, price, download number, effective date, user rating and others or the sorting order comprises one of the following: ascent and descent.

12. The method of claim 9, wherein the application sorting response message comprises at least one of:
a status code, for indicating whether the application sorting is successfully performed; and
an application information list comprising at least one of an application count and at least an application information of at least an application.

13. The method of claim 12, wherein each of the at least an application information of an application comprises at least one of an ID of the application, a name of the application, an ID of a developer who develops the application, a type of the application, an illustrative description of the application, an audit status of the application, a current version of the application, a submitted time of the application, an effective date of the application, an expiration date of the application, a price of the application, a logo of the application, a language of the application, a size of the application, a new features description of the application and a screenshot of the application.

14. A method of application store management in a Telco's Application Store (TAS) system developed by Open Mobile Alliance (OMA), the TAS system having a TAS client component and a storefront component, the method comprising:
transmitting, by the TAS client component, an application search request message to the storefront component, for requesting the storefront component to perform application search; and
receiving, by the TAS client component, an application search response message in response to the application search request message, wherein the application search response message is transmitted by the storefront component.

15. The method of claim 14, wherein the application search request message comprises at least one of an identity (ID) of the TAS client component and one of a quick search and an advanced search.

16. The method of claim 15, wherein the quick search comprises a single string or the advanced search comprises at least one of the following: minimum price, maximum price, developer's name, terminal brand, terminal type and application type.

17. The method of claim 14, wherein the application search response message comprises at least one of:
a status code, for indicating whether the application search is successfully performed; and
an application information list comprising at least one of an application count and at least an information of at least an application.

18. The method of claim 17, wherein each of the at least an application information of an application comprises at least one of an ID of the application, a name of the application, an ID of a developer who develops the application, a type of the application, an illustrative description of the application, an audit status of the application, a current version of the application, a submitted time of the application, an effective date of the application, an expiration date of the application, a price of the application, a logo of the application, a language of the application, a size of the application, a new features description of the application and a screenshot of the application.

19. A method of application store management in a Telco's Application Store (TAS) system developed by Open Mobile Alliance (OMA), the TAS system having a developer's portal component, a developer support component and a storefront component, the method comprising:
transmitting, by the developer's portal component, an application deletion request message to the developer support component, for requesting the storefront component or the developer support component to delete an application; and
receiving, by the developer's portal component, an application deletion response message in response to the application deletion request message, wherein the application deletion response message is transmitted by the developer support component.

20. The method of claim 19, wherein the application deletion request message comprises at least one of an identity (ID) of the developer's portal component, an ID of the application and a reason.

21. The method of claim 19, wherein the application deletion response message comprises a status code, for indicating whether the application is successfully deleted.

22. A method of application store management in a Telco's Application Store (TAS) system developed by Open Mobile Alliance (OMA), the TAS system having a developer support component and a storefront component, the method comprising:
transmitting, by the developer support component, an application deletion request message to the storefront component, for requesting the storefront component to delete at least an application; and
receiving, by the developer support component, an application deletion response message in response to the application deletion request message, wherein the application deletion response message is transmitted by the storefront component.

23. The method of claim 22, wherein the application deletion request message comprises at least one of an identity (ID) of a developer's support component, at least an ID of the at least an application and a reason.

24. The method of claim 22, wherein the application deletion response message comprises a status code, for indicating whether the at least an application is successfully deleted.
